(19) United States
(12) Patent Application Publication
(10) Pub. No.: US 2025/0215945 A1
(43) Pub. Date: Jul. 3, 2025

(54) Dust boot for a brake caliper and brake caliper

(71) Applicant: BREMBO S.P.A., CURNO (IT)

(72) Inventors: Cristian Crippa, CURNO (IT); Lucrezia Ligari, CURNO (IT); Mauro MAMBRETTI, CURNO (IT)

(73) Assignee: BREMBO S.P.A., CURNO (IT)

(21) Appl. No.: 18/989,707

(22) Filed: Dec. 20, 2024

(30) Foreign Application Priority Data
Dec. 27, 2023 (IT) 102023000028020

(51) Int. Cl. F16D 65/00; F16D 55/00; F16D 65/18; F16D 121/04; F16D 125/08

(52) U.S. Cl. CPC F16D 65/0087; F16D 65/18; F16D 2055/0016; F16D 65/0068; F16D 2121/04; F16D 2125/08

(57) ABSTRACT

A dust boot (300) is described, arranged to be coupled to a brake caliper, in which the dust boot (300) has an annular shape defining an axis (x) and comprises:
a radially outer portion (302) having a shape symmetrical to a diametrical plane (P) of the dust boot, which is adapted to be engaged to a seat made in a body of the brake caliper;
a wall (304) extending from the outer portion towards the axis (x) of the dust boot.

A brake caliper is further described.

### TECHNICAL FIELD

The present invention generally belongs to the field of brake calipers; in particular, the invention relates to a dust boot for a brake caliper, and to a brake caliper.

### PRIOR ART

In general, as can be seen, for example in FIG. 1, a brake caliper 100 for a disc brake comprises a body 102, at least one element 104 adapted to support at least one brake pad 106 and at least one piston/cylinder 108 adapted to move said at least one brake pad.

The brake caliper further comprises at least one dust boot. In general, a dust boot is an element adapted to prevent dust/fine dust from entering the seat of the brake caliper body where the at least one piston is to be accommodated.

The dust boots currently produced according to the prior art have a geometry, which only allows the application thereof on one side, making the positioning necessary on the correct side during assembling in the brake caliper, which is initially performed with the assembly of the dust boot on the piston.

This assembly step of the dust boot on the piston must ensure the successive assembly on the brake caliper body, but the same geometry of the seat on the piston does not ensure the correct positioning of the dust boot with respect to the brake caliper body. As a result, the dust boot may also be fitted incorrectly in the brake caliper if appropriate checks and objectifications are not carried out on the line.

Therefore, in the first assembly step, when the dust boot is fitted onto the piston, it is necessary to ensure that said boot is already correctly oriented, to ensure that it interfaces correctly with the brake caliper body.

An example of a dust boot 200 made according to the prior art is shown in FIG. 2.

FIG. 2a shows a sectional view of the dust boot in FIG. 2, according to the cutting plane A.

Furthermore, FIG. 2b shows the dust boot 200 in FIG. 2, when coupled to the body of a brake caliper 202, after being coupled, according to the correct direction of installation, to an example piston of a brake caliper 204.

As can be seen in FIG. 2a and in FIG. 2b, the dust boot made according to the prior art comprises a poka yoke, since said dust boot can only work on one side. A poka yoke, for example, is intended to mean an element adapted to prevent the dust boot from being assembled in an incorrect side.

Furthermore, said dust boot comprises coils made to be assembled correctly on only one side, since assembly on the opposite side is not possible.

In light of the above preceding paragraphs, the dust boots made according to the prior art have at least the following drawbacks:
elevated cost of assembly process in the brake caliper as it is necessary to verify the correct orientation of the dust boot;
a risk of encountering an incorrectly assembled dust boot in the brake caliper.

### SUMMARY OF THE INVENTION

Therefore the objects of the invention comprise:
reducing the cost of the assembly process of the dust boot in the brake caliper, as the orientation of the dust boot is not necessary;
reducing the probability of encountering an incorrectly assembled dust boot;
reducing the cost of producing the dust boot by virtue of a reduction in the amount of material (e.g. rubber) required for the production thereof;
reducing an overall axial volume of the brake caliper, which must accommodate said dust boot.

In short, the present invention is aimed at defining a symmetrical geometry of part of the dust boot, which allows assembling the dust boot on the piston of the brake caliper, without discriminating the position/orientation thereof, as the correct positioning relative to the brake caliper body will nonetheless be ensured by the geometry of the dust boot.

The aforesaid and other objects and advantages are achieved according to an aspect of the invention, by a dust boot having the features defined in claim 1 and according to a further aspect of the invention, by a brake caliper having the features defined in claim 10. Preferential embodiments are defined in the dependent claims, the content of which shall be understood as an integral part of the present description.

### BRIEF DESCRIPTION OF THE DRAWINGS

The functional and structural features of some preferred embodiments of a dust boot and a brake caliper according to the invention will now be described. Reference is made to the appended drawings, in which:

FIG. 1 shows a brake caliper according to the prior art;

FIG. 2 shows a dust boot according to the prior art;

FIG. 2a shows a sectional view, from the cutting plane A, of the dust boot in FIG. 2;

FIG. 2b shows the dust boot in FIG. 2, when coupled to the body of a brake caliper, after being already coupled to an illustrative piston;

FIG. 3 shows a perspective view of a dust boot according to an embodiment of the present invention;

FIG. 3a shows a sectional view, from the cutting plane B, of the dust boot in FIG. 3; and
FIG. 4 shows the dust boot in FIG. 3, when coupled to the body of a brake caliper, after being already coupled to an illustrative piston.

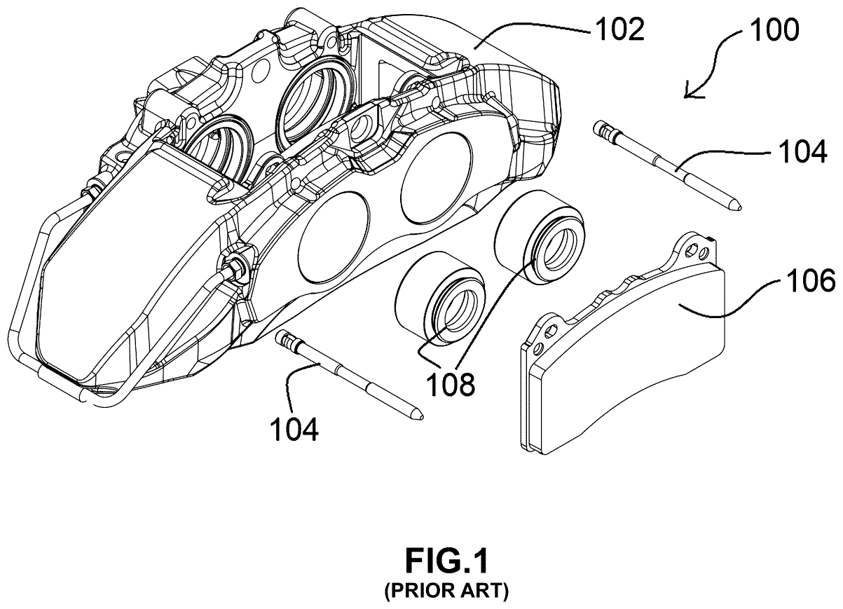

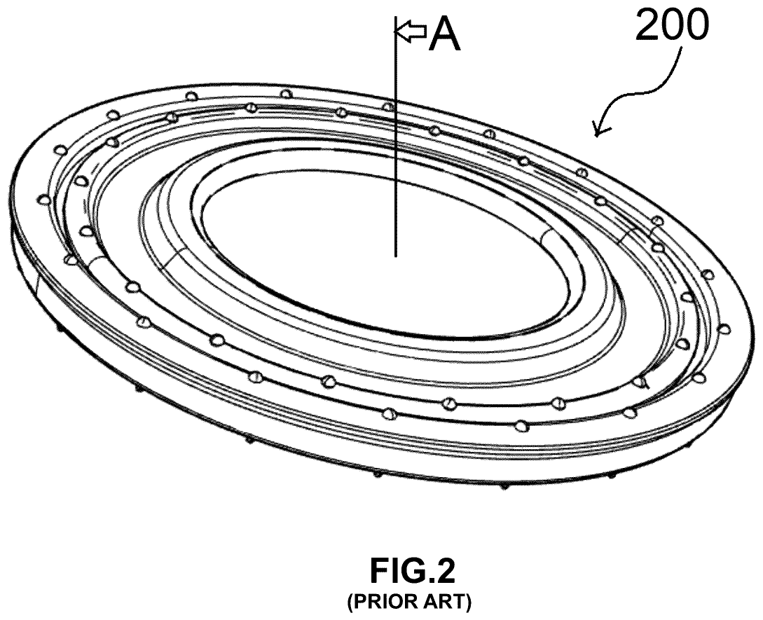

### DETAILED DESCRIPTION

Before explaining, in detail, a plurality of embodiments of the invention, it must be clarified that the invention is not limited, in the application thereof, to the structural details and configuration of the components presented in the following description or shown in the drawings. The invention is basically capable of getting other embodiments and being implemented or made in different ways. It should also be understood that the phraseology and terminology serve a descriptive purpose and should not be understood as limiting. The use of “include” and “comprise” and variations thereof shall be understood as covering the elements set out below and the equivalents thereof, as well as additional elements and equivalents thereof.

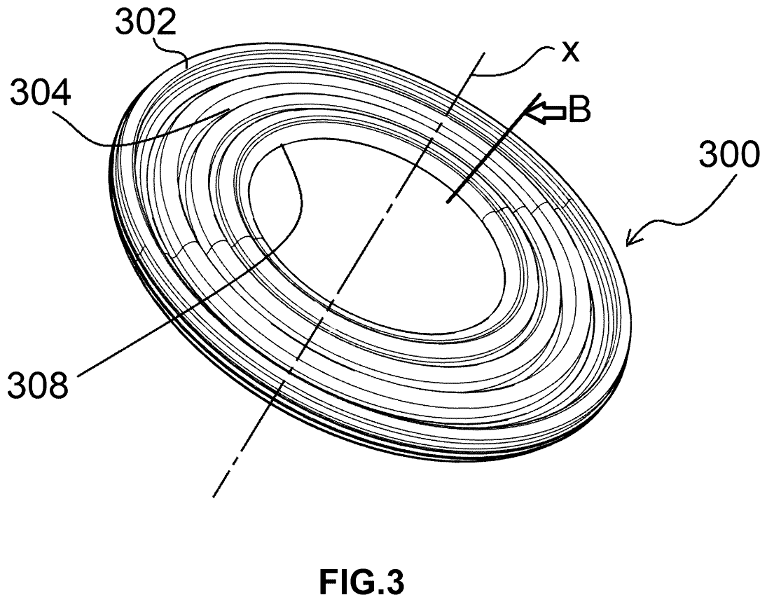

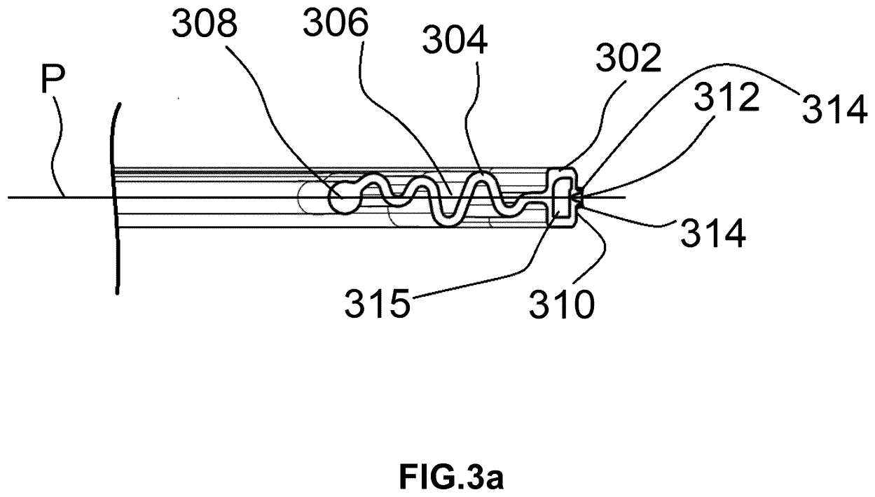

An embodiment of a dust boot 300 is described below with initial reference to FIG. 3.

For example, dust can be understood to mean fine dust/particles created by the wear of a brake pad, when the latter is brought, by a brake caliper, into contact with a braking disc of a disc brake, during a braking action.

The dust boot 300 is arranged to be coupled to a brake caliper.

As can be seen in that FIG. 3, the dust boot 300 has an annular shape defining an axis x. In general, in all the present description and in the claims, the terms and expressions indicating positions and orientations, such as “longitudinal”, “transverse”, “vertical” or “horizontal”, may refer to said axis x.

The dust boot 300 comprises a radially outer portion 302 having a shape symmetrical to a diametrical plane P of the dust boot. Said radially outer portion 302 is adapted to be engaged with a seat made in a brake caliper body. The dust boot 300 further comprises a wall 304 extending from said outer portion 302 towards said axis x of the boot.

In other words, the radially outer portion 302 of the dust boot can form an engagement zone on the brake caliper body, symmetrical to the diametrical plane P of the dust boot.

In an example, the engagement can be obtained by means of an outer seal with a metal ring.

According to the present invention, the radially outer portion 302 of the dust boot, provided for the engagement of the dust boot with the brake caliper body, is optimized in order to be symmetrical and ensure the correct engagement of the dust boot and the sealing of the dust boot.

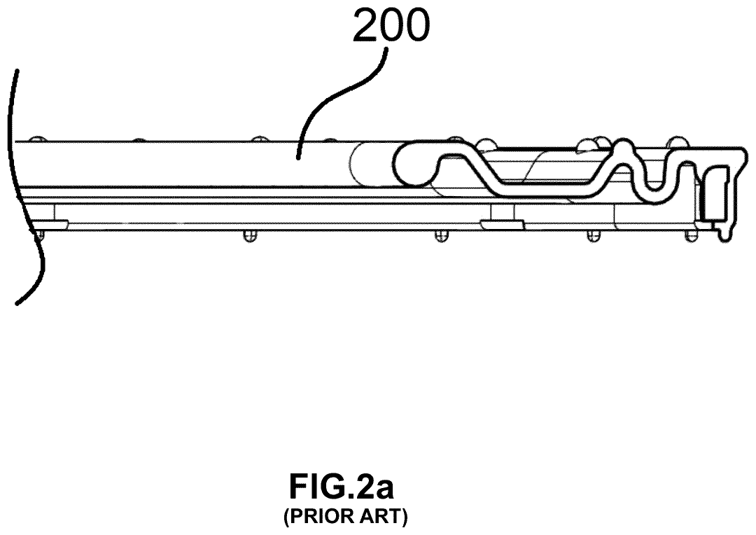

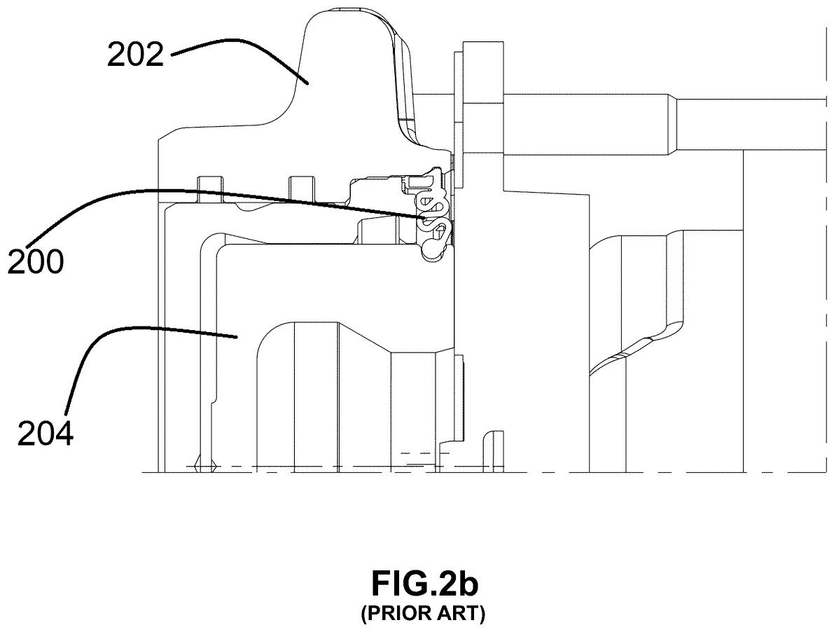

Therefore, with respect to the known dust boot shown in FIG. 2, the dust boot 300 according to the present invention does not require a poka yoke, as it can be assembled on the piston indifferently, from all sides thereof. Advantageously, the symmetrical shape and the removal of the poka yoke can further allow a minimization of material used to make the dust boot and the axial volume occupied by the dust boot.

Preferably, as can be seen for example in FIG. 3a, the wall 304 of the dust boot can preferably have a wavy shaped section, so as to form at least one loop 306.

In other words, the wavy shape can form at least one coil.

The wavy shaped wall 304 preferably does not protrude from said radially outer portion 302 in a direction parallel to said axis x of the dust boot.

In an example, the geometry of the wavy wall 304 may not be symmetrical, but it may have a symmetrical-type behavior and nonetheless ensure the correct functionality and positioning of the boot in both assembly directions. For example, the wavy wall must not protrude outside the piston to ensure that it does not stick to a pad or get stuck and thus be damaged during use. Therefore, the packaging of the at least one coil of the wavy wall can ensure being implemented correctly in both assembly sides, thus respecting the volumes.

The wall 304 of the dust boot can preferably comprise an intermediate wavy portion and a radially inner free end 308. In this case, said radially inner free end 308 can be adapted to be engaged to a piston of the brake caliper.

The radially inner free end 308 of the wall, as can be seen, for example in FIG. 3a, can preferably have a cross-sectional dimension greater than the cross-sectional dimension of said intermediate portion of the wall.

As can be seen in FIG. 3a, preferably, a radially outermost face 310 of the outer portion 302 of the dust boot can comprise a seat 312 running at least in part along an outer circumference of the outer portion. The seat 312 can preferably cover the whole outer circumference of the outer portion.

The seat 312 of the dust boot can preferably comprise a pair of walls 314 radially protruding outwardly from the dust boot. Said walls 314 are such as to locate an invitation adapted to ensure a form fit with a corresponding element made in the brake caliper body. For example, the corresponding element made in the brake caliper body can substantially be made at the opening of the seat, made in the brake caliper body.

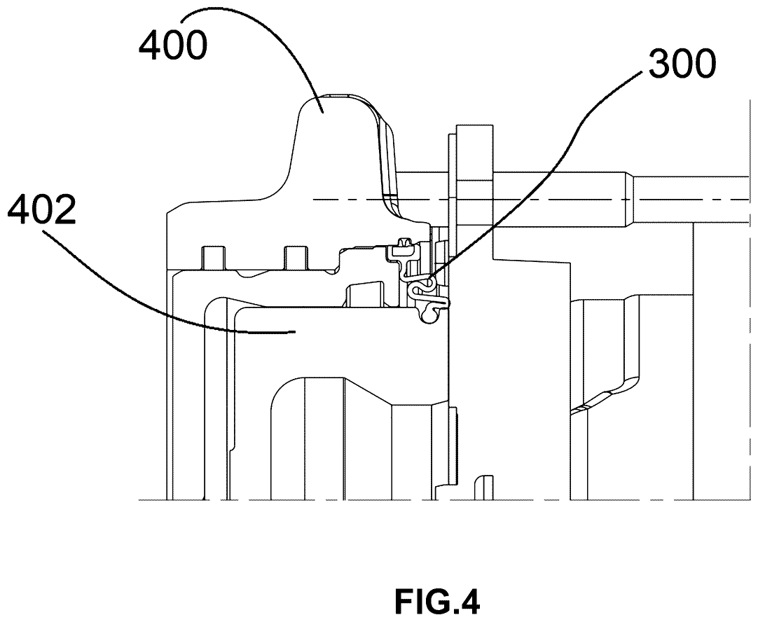

FIG. 4 for example shows the dust boot in FIG. 3, when coupled to the body 400 of a brake caliper after being coupled to an illustrative piston 402 of said brake caliper.

Preferably, the seat 312 of the dust boot may be tapered in a radially inward direction towards axis x of said dust boot.

Preferably, at least part of the outer portion 302 of the dust boot can have an inner cavity 315 circumferentially extending into said outer portion.

In a further aspect, the present invention relates to a brake caliper, in particular for a disc brake.

In one embodiment, the brake caliper comprises:
a brake caliper body comprising a seat;
at least one piston arranged to be accommodated in said seat of the brake caliper body and adapted to move at least one brake pad; and
a dust boot according to any one of the above-described embodiments.

A first advantage achieved by the present invention, against dust boots according to the prior art, is related to the cost, due to a simplified assembly of the dust boot eliminating the need to objectify the orientation of the dust boot in the line.

A second advantage achieved by the present invention is related to a reduction in the production cost of the dust boots, also due to the fact that less material is required.

A third advantage achieved by the present invention relates to the possibility of reducing the volume of the brake caliper, due to the fact that the dust boot of the present invention has a reduced axial volume in the engagement zone of the brake caliper, thus allowing space to be axially gained. The present invention is particularly advantageous for brake calipers designed to be particularly compact.

Different aspects and embodiments of a dust boot and brake caliper have been described, according to the invention. It is understood that each embodiment can be combined with any other embodiment. Furthermore, the invention is not limited to the described embodiments but can be varied within the scope defined by the accompanying claims.

1. Dust boot (300) arranged to be coupled to a brake caliper, wherein said dust boot (300) has an annular shape defining an axis (x) and comprises:
a radially outer portion (302) having a shape symmetrical to a diametrical plane (P) of the dust boot, which is adapted to be engaged to a seat made in a body of the brake caliper;
a wall (304) extending from said outer portion towards said axis (x) of said dust boot.

2. Dust boot according to claim 1, wherein said wall (304) of the dust boot has a wavy shaped section so as to form at least one loop (306).

3. Dust boot according to claim 2, wherein said wavy shaped wall (304) does not protrude from said radially outer portion (302) in a direction parallel to said axis (x) of the dust boot.

4. Dust boot according to claim 1, wherein said wall (304) comprises a wavy intermediate portion and a radially inner free end (308), which is adapted to be engaged to a piston of the brake caliper.

5. Dust boot according to claim 4, wherein said radially inner free end (308) of the wall (304) has a cross-sectional dimension greater than the cross-sectional dimension of said intermediate portion of the wall.

6. Dust boot according to claim 1, wherein a face (310) radially outermost of said outer portion (302) of the dust boot comprises a seat (312) running at least in part along an outer circumference of said outer portion.

7. Dust boot according to claim 6, wherein said seat (312) of the dust boot comprises a pair of walls (314) radially protruding outwardly from the dust boot, wherein said walls (314) are such as to locate an invitation suitable to ensure a form fit with a corresponding element made in said body of the brake caliper.

8. Dust boot according to claim 6, wherein said seat (312) of the dust boot is tapered in a radially inward direction towards the axis (x) of said dust boot.

9. Dust boot according to claim 1, wherein at least part of the outer portion (302) has an inner cavity (315) circumferentially extending into said outer portion.

10. Brake caliper comprising:
a brake caliper body comprising a seat;
at least one piston arranged to be accommodated in said seat of the brake caliper body and adapted to move at least one brake pad; and
a dust boot (300) according to claim 1.
